(19) United States
(12) Patent Application Publication
(10) Pub. No.: US 2013/0297365 A1
(43) Pub. Date: Nov. 7, 2013

(54) SYSTEM AND METHOD FOR COORDINATED SCHEDULING

(71) Applicants: Vincent Montavon, Hopewell Junction, NY (US); Georg Puchta, Menlo Park, CA (US); Carl J. Rohling, Campbell, CA (US)

(72) Inventors: Vincent Montavon, Hopewell Junction, NY (US); Georg Puchta, Menlo Park, CA (US); Carl J. Rohling, Campbell, CA (US)

(21) Appl. No.: 13/844,123

(22) Filed: Mar. 15, 2013

Related U.S. Application Data
(63) Continuation-in-part of application No. 11/563,127, filed on Nov. 24, 2006.
(60) Provisional application No. 60/739,654, filed on Nov. 23, 2005.

(51) Int. Cl. G06Q 10/10

(52) U.S. Cl. CPC G06Q 10/1093
USPC 705/7.18

(57) ABSTRACT

A schedule-coordination system and method that analyzes schedules of a plurality of users and detects schedule overlaps between the users. A first user can be proactively alerted to a schedule overlap with a second user, depending upon registration records of the first and second users. The system and method can also optimize the coordination of a user's schedule by facilitating changes to the schedule.

### CLAIM OF PRIORITY

This application is related to and claims priority under 35 U.S.C. 119(e) to U.S. Provisional Patent Application No. 60/739,654 filed on Nov. 23, 2005 entitled “System and Method for Coordinated Scheduling”, the complete content of which is hereby incorporated herein by reference.

### BACKGROUND

1. Field of the Invention

The present invention relates to a system and method for coordinating the travel and travel-related schedules of a plurality of individuals within a predefined community of individuals.

2. Description of the Related Art

There are many ways for an individual user to effectively schedule their time, including, by way of example and not limitation, paper and electronic calendars, on-line calendars and personal digital assistants (PDAs). The scheduling of travel preferably includes means for proactively alerting a user to upcoming travel-related events in order to afford ample preparation time prior to the commencement of travel. There are several services that proactively make people aware of their own travel arrangements. Such alerting may include an itinerary that is sent to the traveler. The method of itinerary delivery can include email, text messaging or a verbal reminder. Other methods of reactive alerting can be performed when an individual visits a service provider's website wherein the individual goes to the website to view their itinerary for travel details. Exemplary service providers include airline reservation systems, rental car companies, online booking services, company-sponsored websites, travel agents and hotels.

There are other websites that provide travel related services regarding traveler's travel details such as Continento.com. This service allows travelers and invited users to have access to the traveler's travel details while the traveler is traveling, for example, while the traveler is on vacation. This is a service geared mainly towards leisure travel and is reactive in that the invited users must log on to a website to view descriptions of their travel companions' experiences while traveling to different vacation destinations.

While individuals have the means described above to manage their schedule and, more particularly, their travel schedules, methods of schedule coordination remain cumbersome. Travelers (including, without limitation, co-workers, companions, business associates, friends and family members) must communicate scheduling details by, for example, meeting in person, telephone, facsimile, email or paper mail. Entire itineraries are commonly exchanged. Coordination of travel itineraries can then require multiple users to compare multiple itineraries, seeking areas of overlap among itineraries, and proposing changes or additions to itineraries by the methods recited above, and, repeating the manual comparison process to ensure a desired level of coordination. Such a process is rife with opportunities for error, is cumbersome, and may require multiple attempts at coordination before a desired result is achieved.

Given the difficulties described above, most travelers are not aware that they will be, are, or were essentially in the same location at the same time as one another, and miss opportunities to maximize the benefit of travel by, for example, conducting a business meeting or social engagement.

There is thus a need in the art for a system and method for coordinating individuals' schedules and, in particular, their travel schedules.

### BRIEF DESCRIPTION OF THE DRAWINGS

FIG. 1 depicts an embodiment of a schedule coordination system in the context of a database and a plurality of users.

FIG. 2 depicts exemplary interactions between a schedule coordination system and users of the schedule coordination system.

FIG. 3 depicts an embodiment of a schedule coordination system.

FIG. 4 depicts a registration record.

FIG. 5 depicts a class diagram of an itinerary.

FIG. 6 depicts a notation of a schedule overlap.

FIG. 7 depicts an embodiment of a structure for persisting notifications of schedule overlaps;

FIG. 8 depicts an exemplary notification criterion detected, wherein two users having a mutual affiliation may be detected to be scheduled in the same location at the same time.

FIG. 9 depicts exemplary relationships between users.

FIG. 10 depicts an exemplary notice of an invitation to affiliate with a registered user.

FIG. 11 depicts an exemplary notice of acceptance of affiliation.

FIG. 12 depicts an exemplary notice of a schedule overlap.

FIG. 13 depicts a method of extracting schedule information from a message.

FIG. 14 depicts a flowchart of a registration and login process.

FIG. 15 depicts a flowchart of a process associated with inviting another registered user to set up a mutual affiliation.

FIG. 16 depicts a flowchart of a process associated with accepting or declining another user's invitation for a mutual affiliation.

FIG. 17 depicts a flowchart of a process associated with deleting an existing affiliation.

FIG. 18 depicts a flowchart of a process associated with adding a new or modifying an existing itinerary.

FIG. 19 depicts a flowchart of a process associated with adding a new or modifying an existing itinerary and previewing itinerary overlaps with members.

FIG. 20 depicts an exemplary notification process, wherein a user receives notifications resulting from detection of status changes with multiple affiliated users.

FIG. 21 depicts the interoperation of one embodiment of the invention with different kinds of information and reservation systems, local as well as remote, e.g., connected via the interne.

FIG. 22 depicts an exemplary computer system.

FIG. 23 depicts an exemplary itinerary.

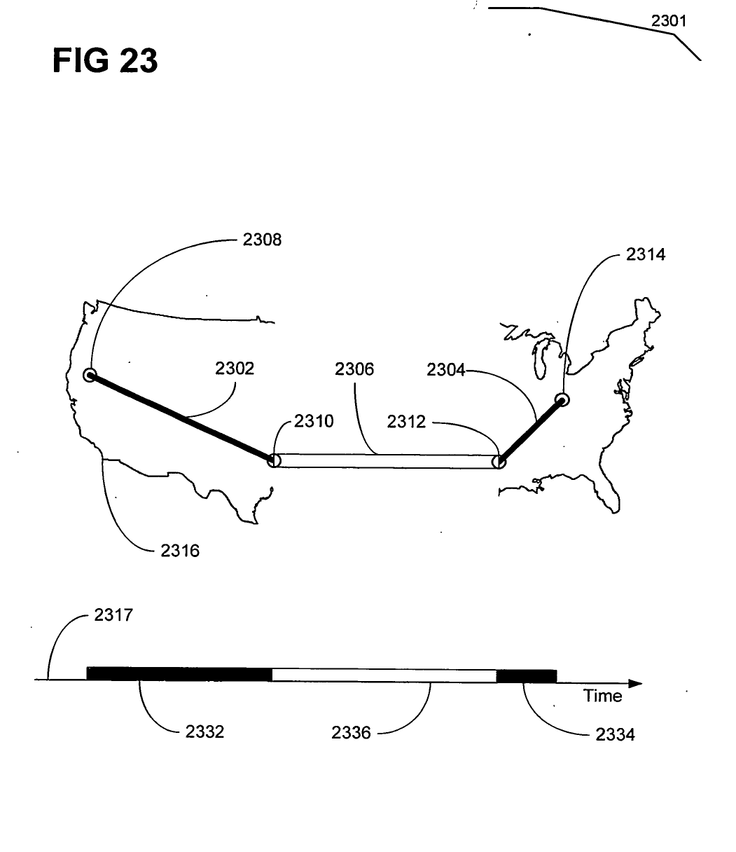

FIG. 24 depicts exemplary geographic tolerances.

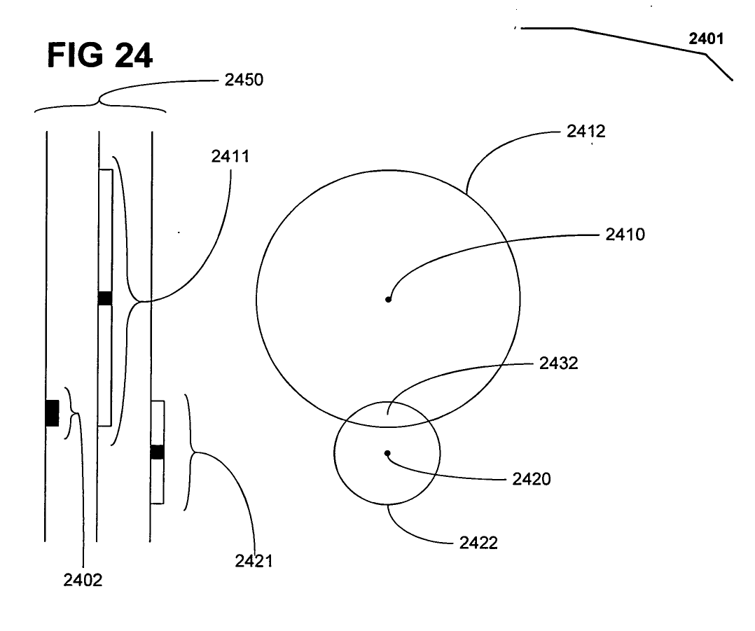

FIG. 25 depicts exemplary combined tolerances

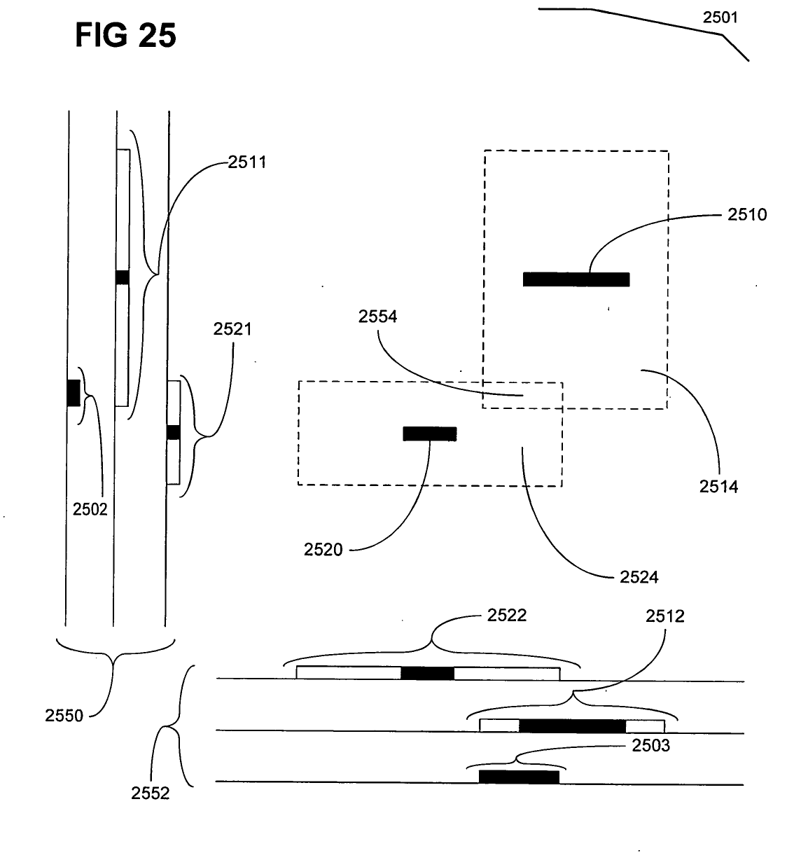

FIG. 26 depicts states of notification criterion detection.

### DETAILED DESCRIPTION

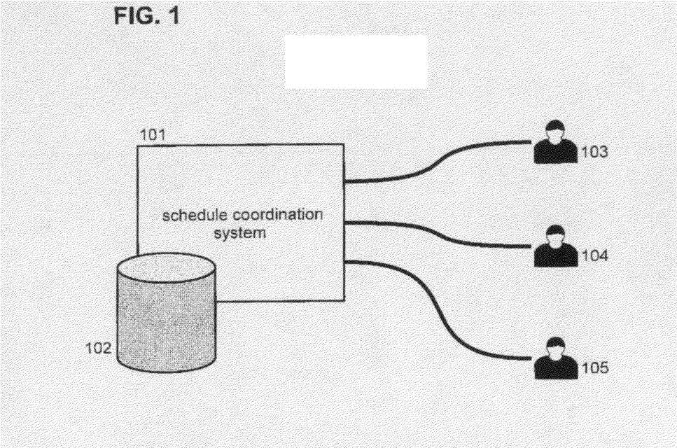

FIG. 1 illustrates a system 101 that functions to coordinate schedules.

In some embodiments a plurality of users 103 104 105 can interact with the system.

Users can be registered users. There can be a registration record known to and/or within the system, wherein a registration record can correspond to a registered user. A registration record can include identification information of a user and/or preferences of a user and/or any other known and/or convenient forms of information pertaining to a user. In some embodiments a user can enter and/or otherwise supply required elements of information in order to complete a registration process. That is, completion of a registration process for a user can result in the user achieving a registered state wherein the user becomes a registered user. In some embodiments one or more of the required elements and/or combinations and/or derivative forms of the required elements of information can be included in a registration record corresponding to a user. In alternative embodiments a user can enter and/or otherwise supply essentially no required elements of information but may still complete a registration process. In alternative embodiments there may be essentially no required elements of information, and/or a user can enter and/or otherwise supply other elements of information during a registration process. In still further alternate embodiments, an email address can be a required element for registration.

A user can be, but is not necessarily, an individual person. By way of non-limiting example, a user can be a demonstration user and/or a typical user and/or representative of a group of individuals and/or any other known and or convenient form of user that does not correspond to an individual person.

In some embodiments a user can be another system of the same type, another system of a different type, and/or another system of a type that does not correspond to an actual system. By way of non-limiting example, a user can be a demonstration system and/or a typical system and/or representative of a group of systems and/or any other known and/or convenient form of a user that does not correspond to an actual system.

In some embodiments there can be additional forms of users. By way of example and not limitation there can be a system administrator user.

By way of non-limiting example, there can be a user that is a member of every other user in a group of users. It can be appreciated that in some embodiments such a user can track the itineraries of a selected group of users. In some embodiments such a user can track and/or provide tracking of the locations and/or other kinds of information of group members whose corresponding itineraries are in and/or otherwise known to the system.

In some embodiments one or more aspects of the schedule coordination system can be implemented through the use of software processes that function in the context of a computer system.

Various kinds of information that can be used by the schedule coordination system can be represented as data. In some embodiments some types of information can be resident and/or managed within a database system. Some types of information can reside wholly and/or in part outside the schedule coordination system. By way of non-limiting example, a collection of itineraries may reside in data storage 102 outside of and possibly remote to the schedule coordination system. By way of further non-limiting example, an entire database management system and/or the data managed by the database management system can reside outside of and remote to the schedule coordination system, wherein the schedule coordination system has access to the functionality and content of the database management system. That is, data and/or data management facilities used in the practice of an embodiment of the schedule coordination system need not reside wholly within nor be co-located with the schedule coordination system.

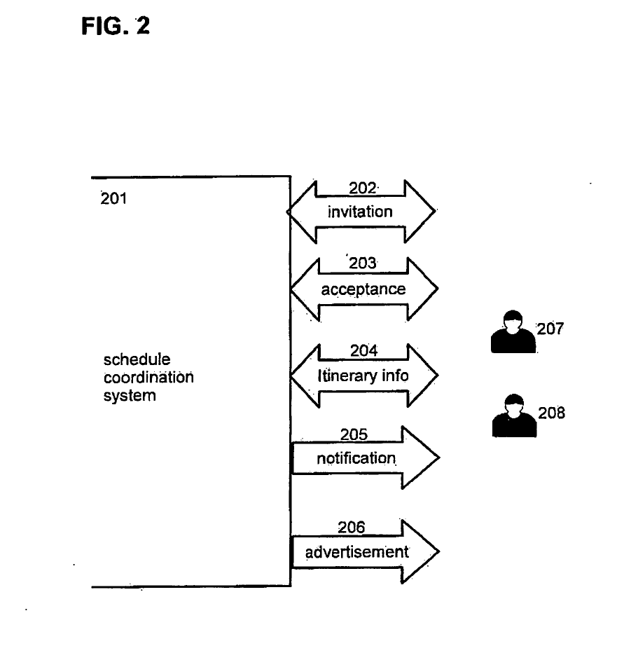

FIG. 2 depicts exemplary interactions between a schedule coordination system 201 and users of the schedule coordination system: a first user 207 and a second user 208.

A user having achieved a registered status is a registered user. User 207 can be a first registered user, an “inviter”, and can utilize the system 201 to extend an invitation to a second user 208, offering the second user an opportunity to affiliate with the first registered user. The second user 208, the “invitee”, can be an unregistered user or a registered user when invited. However, in some embodiments affiliation is only available to registered users. An opportunity for an unregistered invitee to achieve registered status, that is, to register, can be offered in concert with the invitation to affiliate but need not be included therein.

Figure element 202 indicates interaction regarding invitations between a users 207 and 208 and a schedule coordination system 201. A first user 207 can be a registered user, and can interact with the system in order to generate an invitation to user 208. A second user 208 can receive an invitation from the system 201; the invited second user can be designated an invitee.

Having received an invitation to affiliate, an invitee 208 can interact with the system as illustrated by figure element 203, in order to accept the invitation. In some embodiments, an invitee 208 must achieve registered status prior to accepting and/or participating in affiliation with another user, such as the first user 207. Notice of an invitee's acceptance of an inviter's invitation can be communicated to an inviter 207 as illustrated by figure element 203.

An itinerary can comprise information elements that describe and/or pertain to planned events and/or actions. An itinerary can correspond to an individual and/or a user 207. An individual and/or a user can have a plurality of corresponding itineraries. Elements of an itinerary can include by way of non-limiting example: locations, lodging, transportation, meetings, appointments, events, contact information, resource information, reservation codes, and schedule information. Locations can include specific geography, cities, airports, and/or any other known and/or convenient descriptions of location. Lodging can include hotels, motels, and/or any other known and or convenient forms of lodging. Transportation can include airplane flights, rental cars, transport by rail, ferries, cruise ships, and/or any other known and/or convenient forms of transportation. Schedule information can apply to any of the other elements described herein and/or any other known and/or convenient elements of an itinerary.

Figure element 204 illustrates user interaction with the schedule coordination system 201 regarding itineraries. In some embodiments, the itineraries can be stored into a data store. A user 207 can provide one or more itineraries corresponding to that user, providing each itinerary in whole and/or in part, to the system. In some embodiments a user 207 can alter and/or update itinerary information through interaction 204 with the system. In some embodiments the system 201 can extract itinerary information from a message, such as by way of non-limiting example, a text message, an email message, and/or any other message. In some embodiments the system 201 can extract and/or otherwise obtain itinerary information from records in and/or generated by another system, such as a computer travel reservations system. The extracted and/or otherwise obtained itinerary information can be used to update and/or populate an itinerary corresponding to a user 207. A user 207 can also receive itinerary information from the system. It can be appreciated that a single itinerary of the schedule coordination system can comprise travel information from a plurality of service providers, such as by way of non-limiting example, a plurality of airlines. In some embodiments the system can provide, to a first user 207, updated information regards the first user's own corresponding itinerary or itineraries and/or updates to one or more itineraries corresponding to a second user 208, wherein the second user is affiliated with the first user.

The system 201 can provide notifications 205 to a user 207. In some embodiments the system can notify a first user 207 of a schedule overlap in an itinerary corresponding to a first user 207 and an itinerary corresponding to a second user 208. In some embodiments the system can notify a first user 207 to a change in an itinerary corresponding to a second user 208 that is affiliated with the first user. In some embodiments, the second user 208 can be considered an affiliated second user 208. It can be appreciated that a first user 207, having been notified of a schedule overlap with a second user 208, can benefit from receiving a second notification from the system, responsive to changes in the second user's itinerary, indicating a change in the schedule overlap. It can be appreciated that in some embodiments the system can provide notification to a first user 207 of a change in the first user's itinerary.

In some embodiments a user 207 can provide and/or otherwise indicate a message to accompany or otherwise be conveyed to a second user 208 by the system 201 in the context of selected interactions between the system 201 and the second user 208. By way of non-limiting example, a first user 207 can provide a custom message regarding a first user's itinerary that the system can convey to a second user 208. The custom message can be conveyed in association with notifications regarding the first user's itinerary that are communicated to the second user 208.

In some embodiments the system 201 can provide advertising information to a user 207 as illustrated by figure element 206. In some embodiments advertising provided to a user 207 can be coordinated with elements of an itinerary corresponding to the user. By way of non-limiting example, advertising for a future concert event in a particular city on a particular date can be provided to a user 207 whose itinerary information indicates that the user's location will be within a convenient distance of the particular city on the particular date.

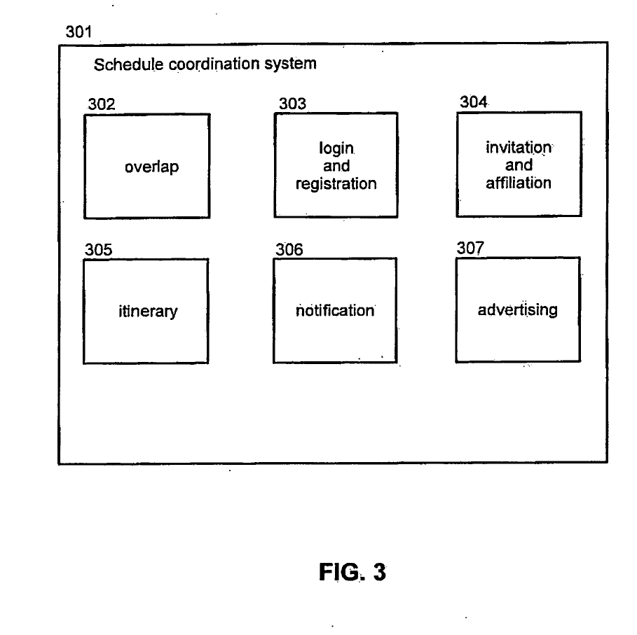

FIG. 3 depicts an embodiment of a schedule coordination system 301, including specific processes associated with functionality of the system. Overlap 302 can support detection of schedule overlaps between users. In some embodiments, the overlaps can be between registered users. Login and Registration 303 can support login and registration capabilities. Invitation and Affiliation 304 can support invitation and affiliation capabilities, including capabilities pertaining to acceptance of invitations to affiliate. Itinerary 305 can support acquisition and management of itinerary information. Notification 306 can support the issuance and management of notifications. Advertising 307 can support the coordination of advertising information with itineraries and/or invitations and/or notifications.

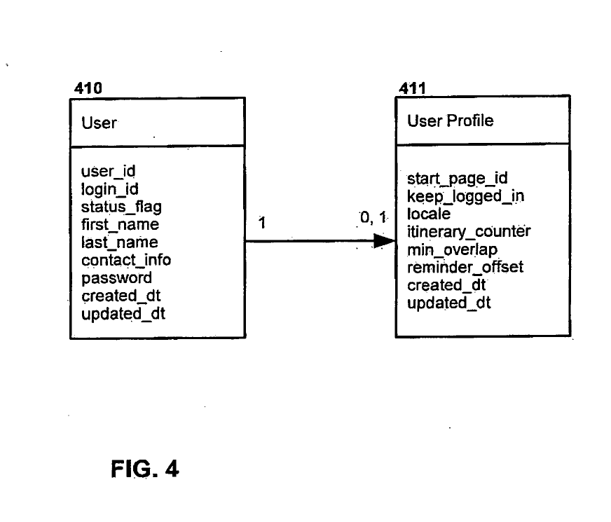

FIG. 4 is a class diagram depicting a registration record according to some embodiments. A registration record corresponding to a user can be instantiated as User 410 and in some cases additionally with User Profile 411.

User 410 can contain fields user id, login_id, status_flag, first_name, last_name, contact_info, password, created_dt, updated_dt, and/or any other desired field.

In the event that an invitation is issued to a user (invitee) a corresponding registration record can be instantiated. In this registration record the entry login_id can contain an email address that can be to invite the corresponding user to affiliate and/or register. The field status_flag can be set to “I” to represent the state of being invited. Other fields in User can be empty. The corresponding User Profile 411 contains no record.

In the event that the invitee achieves a registered status, previously unpopulated fields can be populated with information provided during the registration process. The field status_flag can be set to “A” to indicate an active user. Fields first_name and last_name can be populated with data corresponding to first and last names associated with the invitee. User Profile 411 contains one record, whose fields are populated with appropriate specific information corresponding to the now-registered invitee. In some embodiments User Profile 411 can contain fields start_page_id, keep_logged_in, locale, itinerary_counter, min_overlap, reminder_offset, created_dt, updated_dt, and/or any other desired field.

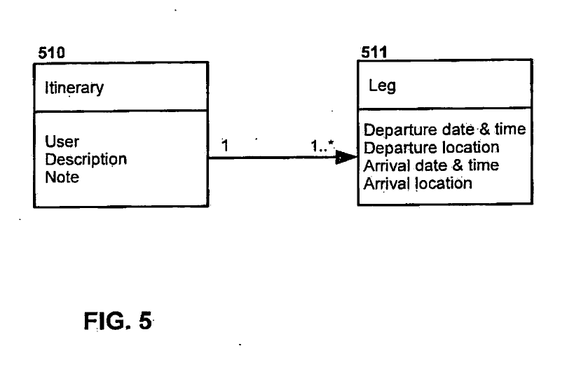

FIG. 5 is a class diagram depicting an itinerary according to some embodiments. An Itinerary 510 can contain a field, “User”, for identifying the corresponding user. In addition an Itinerary can contain fields for Description and Note. One or more instantiations of a Leg 511 can be associated with each Itinerary. A Leg 511 can contain fields for Departure date and time, Departure location, Arrival date and time, Arrival location, and/or any other desired data.

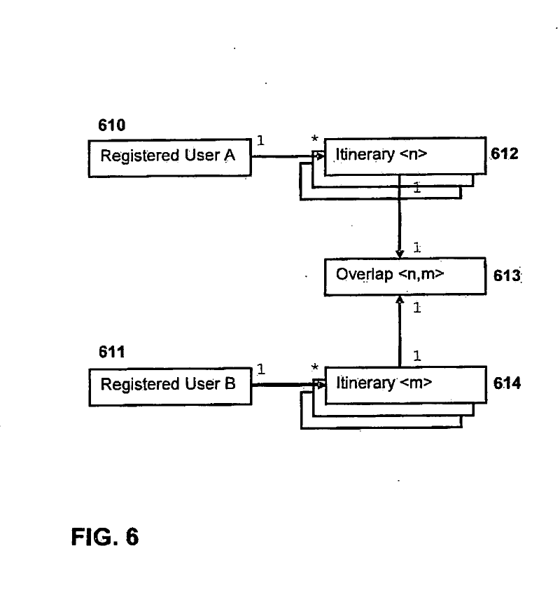

FIG. 6 is a class diagram depicting a notation of a schedule overlap according to some embodiments. An Overlap 613 contains entries to identify itineraries. In this example Itinerary<n> 612 and Itinerary<m> 614 are notated to have a schedule overlap by entries n and m representing the two itineraries associated with the schedule overlap. Each itinerary corresponds to a Registered User, in this example. Itinerary<n> 612 corresponds to and is associated with Registered User A 610, and Itinerary<m> 614 corresponds to and is associated with Registered User B 611.

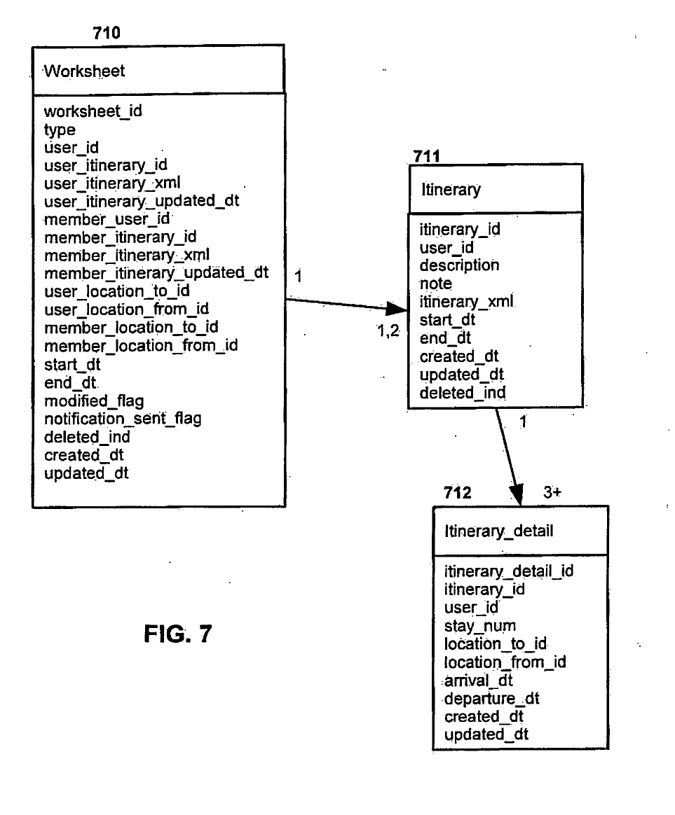

FIG. 7 is a class diagram depicting a worksheet table that is used to persist notifications of schedule overlaps according to some embodiments. The same structure can be used to persist notifications for other events, such as an update to an itinerary. A first user can have an affiliation with a second user. In addition, the first user can have an affiliation with a third user, and so on. The term “member” is introduced to describe users who have an affiliation with a particular first user. That is, if a first user is affiliated with a second user, the first user is a member of the second user, and the second user is a member of the first user.

Worksheet 710 can include entries for a first user and entries for a member of that user. There can be one or more entries in the worksheet in addition to the user_itinerary_xml and member_itinerary_xml entries shown. These entries, user_itinerary_xml and member_itinerary_xml, can each contain a complete XML description of a user's itinerary and a member's itinerary, respectively. Those corresponding itineraries can be associated with the worksheet as shown by Itinerary 711. That is, there can be two instances of an Itinerary 711 associated with each instance of a Worksheet 710. Each instantiated Itinerary 711 can have a plurality of associated details, as shown by Itinerary_detail 712. Entries in Itinerary_detail 712 can include information elements such as schedule information for arrivals and departures at designated locations and/or any other desired data.

Notification Criterion Detection

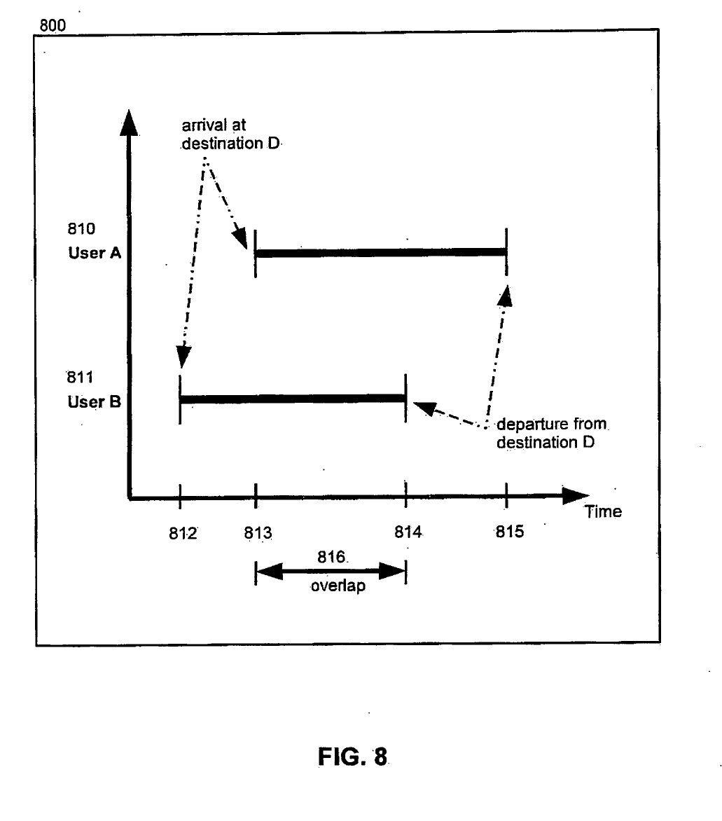

FIG. 8 depicts in a graph 800 an exemplary notification criterion detected, wherein two users having a mutual affiliation may be detected to be scheduled in the same location at the same time. In some embodiments this criterion may be sought in a database search. Such a search and the mechanisms for performing such a search are well understood in the art.

In this simple example, two users, User A 810 and User B 811, arrive and depart from a common location, destination D. User B arrives at a first time 812 in the graph, prior to the arrival of User A at second time 813 in the graph. User B departs at a third time 814 in the graph, prior to the departure of User A at a fourth time 815 in the graph. Hence the two users are potentially “in the same location” during the time interval from 813 to 814, shown as overlap 816 in the graph. The phrase “in the same location” is used to indicate a degree of proximity. By way of non-limiting example, destination D could be an international airport, and the users' arrival and departure times herein described could correspond to individual flight arrival and departure schedules for each of the users.

By way of non-limiting example, if User A and User B are mutually affiliated, and their itineraries and preferences have been previously established on an embodiment of a schedule coordination system as described herein, then the system can detect, and can notify each of the users of, their upcoming mutual proximity, also known as a schedule overlap.

It can be appreciated that the function of identifying a helpful degree of proximity amongst the itineraries of two users can be responsive to preferences of the users.

By way of non-limiting example, for the example above, airports that are within a predetermined distance from one another could be considered to meet the geographic criterion for a schedule overlap. Similarly, arrival and/or departure times that are within a predetermined amount of time of each other could be considered to meet the chronological criterion for a schedule overlap.

As used herein, chronological can mean either “of or pertaining to time” and/or “arranged in the order of time.”

In some embodiments such preferences for geographic and chronological proximity can be expressed as preferences associated with a user's registration record. By way of example and not limitation, users may choose to be notified of the potential of a schedule overlap that would require one or more of the users involved to alter previously established elements of their itinerary.

It can be appreciated that the function of identifying a helpful degree of proximity amongst the itineraries of two users can be responsive to a variety of criteria, and not limited to the examples provided herein of chronological and geographic criteria. Alternative embodiments of the schedule coordination system can be responsive to a variety of criteria for detecting schedule overlaps.

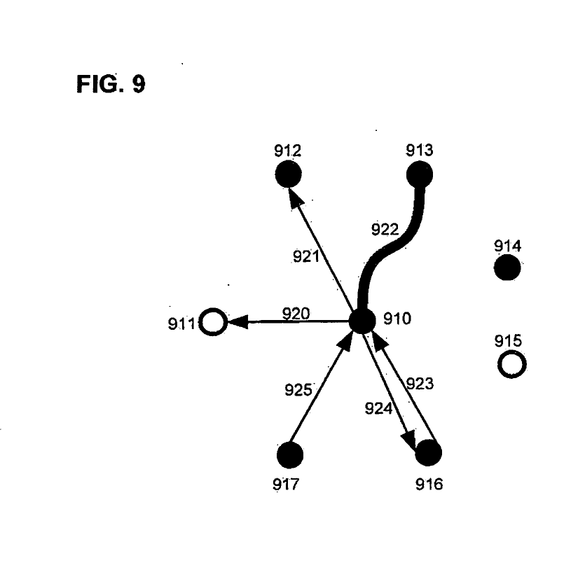

FIG. 9 depicts exemplary relationships between users in an embodiment.

Registered user 910, depicted as a solid disk, is shown in context of relationships to other registered users 912, 913, 914, 916, 917 and unregistered users 911 and 915, shown as unfilled disks. Registered user 910 has invited registered user 912 to affiliate, as shown by the invitation 921. Registered user 910 has also invited unregistered user 911 to affiliate, as shown by the invitation 920. Registered users 910 and 913 are mutually affiliated, as shown by the affiliation 922. Registered user 914 and unregistered user 915 have neither affiliations nor invitations extant with the other users in the diagram. Registered user 917 has invited registered user 910 to affiliate, as shown by the invitation 925. Registered users 910 and 916 have each invited the other to affiliate, as shown by invitations 923 and 924.

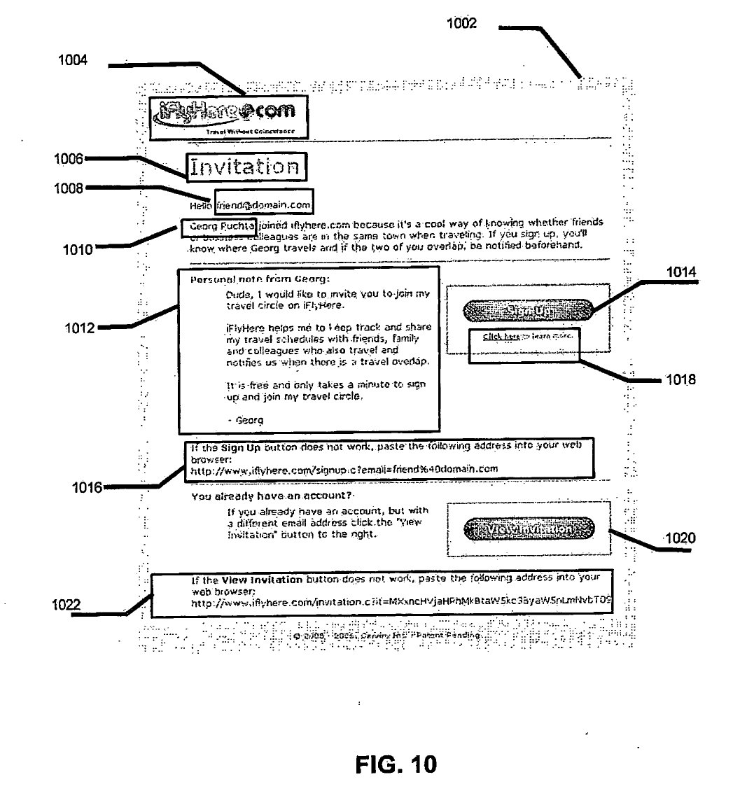

In FIG. 10, element 1002 depicts an exemplary notice of an invitation to affiliate with a registered user, in an embodiment. The notice can be embodied as an email message and/or embodied as a web page displayable by a web browser and/or embodied by any other known and/or convenient forms of messaging.

Provider identification 1004 identifies a provider of the services of a schedule coordination system. The identification can be a logo. Provider identification 1004 can have a link to information and/or services associated with that provider. By way of non-limiting example, the link can be embodied as a URL.

A label 1006 identifies the message as an invitation.

Invitee identity 1008 is shown. The identification can be the invitee's email address or another identifier.

Inviter identity 1010 is shown. In some embodiments the inviter is a registered user who has issued an invitation to the invitee.

A personal message 1012 from the inviter to the invitee is shown in the figure.

A first link 1014 provides a link which when followed, enables the invitee to register for the service and/or view an invitation to affiliate. A second link 1016 provides an alternative to that of the first link 1014. Following the second link 1016 can enable an invitee to register for the service and/or view an invitation to affiliate.

A third link 1018 is a link to additional information regards the service and/or provider(s) of services.

An invitee who is a registered user can follow a fourth link 1020 to view an invitation to affiliate.

A fifth link 1022 provides a linking alternative to that of the fourth link 1020. Following the fifth link 1022 can enable an invitee to view an invitation to affiliate.

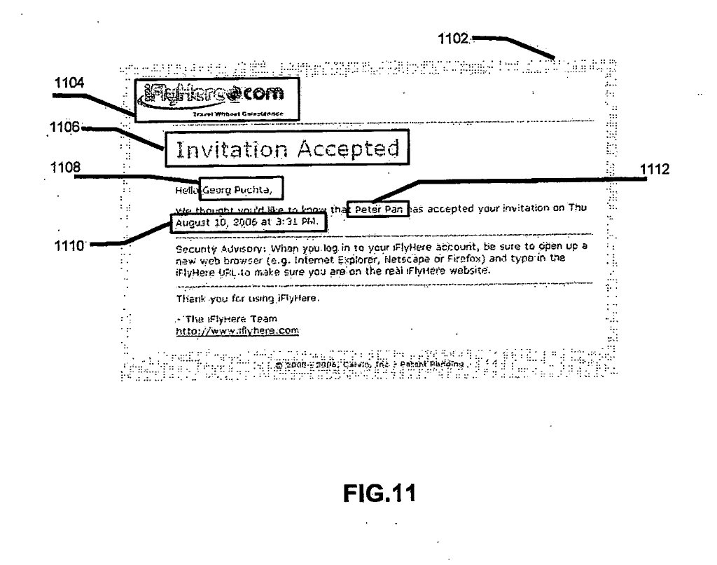

In FIG. 11, element 1102 depicts an exemplary notice of acceptance of affiliation, in an embodiment. The notice can be embodied as an email message and/or embodied as a web page displayable by a web browser and/or embodied by any other known and/or convenient forms of messaging.

Provider identification 1104 identifies a provider of the services of a schedule coordination system. The identification can be a logo. Provider identification 1104 can have a link to information and/or services associated with that provider. By way of non-limiting example, the link can be embodied as a URL.

A label 1106 identifies the message as an acceptance to an invitation.

Inviter identity 1108 is shown. The identification can be the inviter's email address or another identifier. In some embodiments the inviter is a registered user who has issued an invitation to an invitee.

Invitee identity 1110 is shown. The identification can be the invitee's email address or another identifier.

A timestamp 1112 is a record of the time at which an invitation was accepted.

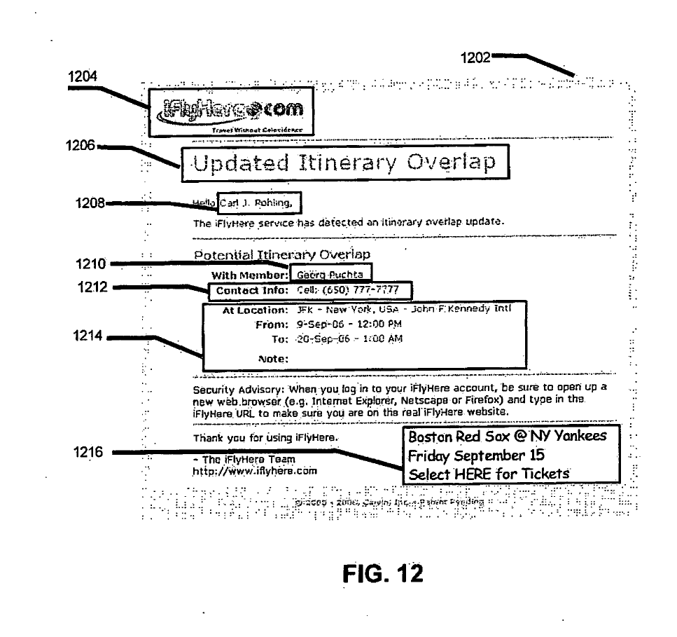

In FIG. 12, element 1202 depicts an exemplary notice of a schedule overlap amongst a first user and a second user, in an embodiment. The notice can be embodied as an email message and/or embodied as a web page displayable by a web browser and/or embodied by any other known and/or convenient forms of messaging.

Provider identification 1204 identifies a provider of the services of a schedule coordination system. The identification can be a logo. Provider identification 1204 can have a link to information and/or services associated with that provider. By way of non-limiting example, the link can be embodied as a URL.

A label 1206 identifies the message as notice of a schedule overlap.

A first user's identity 1208 is shown. The identification can be the first user's email address or another identifier.

A second user's identity 1210 is shown. The identification can be the second user's email address or another identifier.

Contact information 1212 associated with the second user is shown.

Schedule overlap details 1214 are shown. By way of non-limiting examples, details can include geographic and chronological information, that is, places and times. Details can also include other itinerary information. In the example shown, details can also include notes.

Advertising 1216 can be coordinated with the schedule overlap. Shown here by way of non-limiting example is an advertisement for an entertainment event scheduled to occur proximate to the location and during the duration of the schedule overlap of this notice.

In some embodiments the first user and the second user are mutually affiliated. The first user is a member of the second user, and the second user is a member of the first user. By taking advantage of the notices of schedule overlap, the mutually affiliated users, that is, members, obtain a beneficial opportunity to arrange for, and/or participate in, activities together. In an alternative embodiment these same capabilities can be used to avoid potential meetings and/or common activities

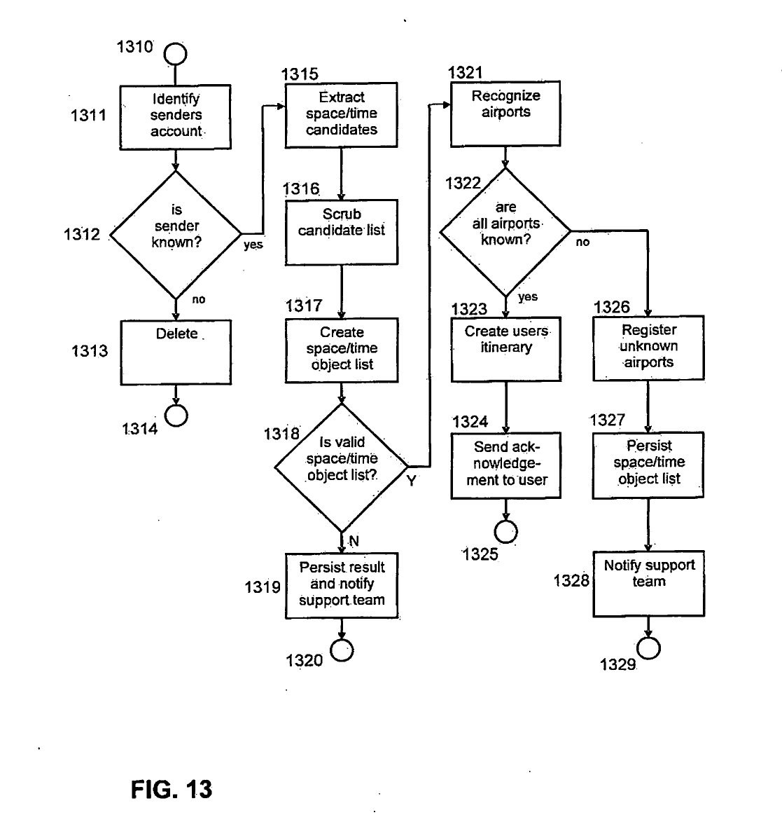

FIG. 13 depicts a method of extracting schedule information from a message. By way of non-limiting example, in some embodiments the message can be an email message. Step 1310 is an entry point that begins the method. Step 1311 identifies the account of the sender of the message. In some embodiments a sender's account can be recognizable as an entry in the “from” field of an email message. Step 1312 tests the sender's account against a record of known accounts. If the sender's account is known, then control flow proceeds to step 1315. Otherwise, the message is deleted in step 1313, and the processing of this message is complete at the exit point of step 1314.

An itinerary can comprise a plurality of legs. Each leg can have a starting location and time, that is, a start point, as well as an ending location and time, that is, an end point. A space/time object can correspond to a point in a leg, that is, a start point or an end point.

Step 1315 extracts space/time candidates from the message. In some embodiments this extraction can be accomplished by parsing techniques or other mechanisms well known in the art. Step 1317 creates a space/time object list. Step 1318 checks for validity of the space/time object list. Some non-limiting example criteria for a valid space/time object list can include: a) space/time objects must occur pairwise; one point corresponding to a departure and another point corresponding to an arrival, both points within a leg, and, b) not less than two legs, that is, four points.

If the space/time object list is valid, then control flow proceeds to step 1321.

Otherwise, control flow passes from step 1318 to step 1319, wherein the current state of results are persisted, that is, a record is made of the current state. In addition, action can be taken to notify a support team. In some embodiments a support team can take actions to remedy an invalid itinerary. The processing of this message is then complete at the exit point of step 1320.

Step 1321 analyzes airports that have been instantiated in the space/time object list. Step 1322 tests if all of the airports are previously known to the system. By way of non-limiting example, in some embodiments airports can be known to they system as three-letter codes, such as SFO, ORD, JFK, etc. In the event that an airport name in a message does not correspond to a known three-letter code of this example, the system may not correctly identify an association with a particular airport. For example, “San Francisco Int. Airport” could correspond to SFO but not yet be known to the system as such.

If all of the airports are previously known to the system, then control flow passes to step 1323. Otherwise, control flow passes from step 1322 to step 1326.

Step 1323 creates an itinerary associated with the user who is the sender of the message. In some embodiments, Step 1323 can create an itinerary associated with the user who is the sender of the message and store the itinerary into the data store. Step 1324 issues an acknowledgement to the user. This method is then completed at the exit point of step 1325.

Step 1326 registers previously unknown airports to the system. Step 1327 persists, that is, makes a record of, the current space/time object list. In step 1328, action can be taken to notify a support team. In some embodiments a support team can take actions to remedy one or more unknown airports. By way of non-limiting example, an instance of an unknown airport such as “San Francisco Int. Airport” could be mapped to a known airport, SFO. This method is then completed at the exit point of step 1329.

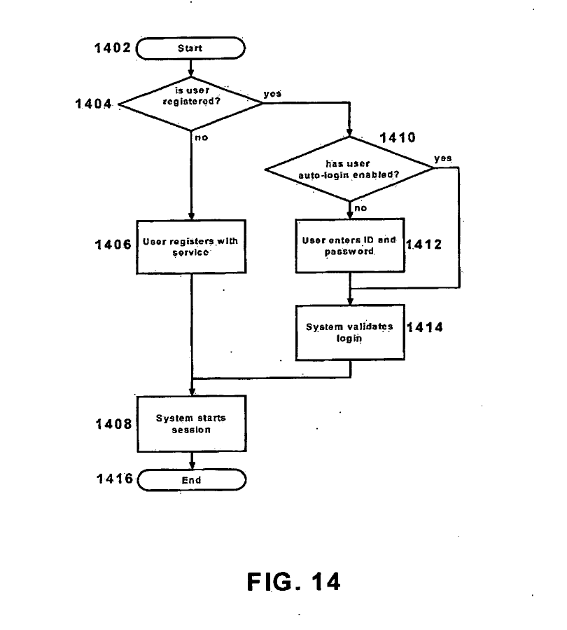

FIG. 14 depicts a flowchart of a system registration and login process. In one embodiment, new users must complete a sign-up process before using the service. The sign up process requires a user to enter required elements of information and to agree to terms of service.

Additional information related to enhancing the user experience may be provided. A user is logged in once the sign-up process has successfully completed. In one embodiment, a user may choose to be logged in automatically or to be forced to provide user credentials when returning to the service. This feature can be changed at any time by altering a user profile. The behavior of this setting is explained in detail below.

Registered users must login before using the service. If a user's profile is set to request the user credentials every time the user returns to the service, the system will prompt a user to enter this information before allowing the user to proceed. Once a user has entered this information and initiates the login process, the system logs in the user if their credentials have been successfully validated. If credential validation is not successful, the system will prompt the user to correct the error and to try again until the validation succeeds.

Step 1402 is an entry point to the process.

Step 1404 splits control flow depending on the user's registration status. If the user is a registered user, control continues to step 1410. If the user is not registered, control continues to step 1406. Step 1406 registers a user.

In step 1408, the user can start a session with the schedule coordinating system. Control thereupon flows to an exit point step 1416.

Step 1410 splits control flow depending on the status of an automated login capability. If the user has auto-login enabled, then control continues to step 1414. Otherwise, the user enters identification and password information as shown in step 1412, whereupon control continues to step 1414. In step 1414 the system validates login information, and proceeds to step 1408, described above.

The steps shown in FIG. 14 comprise, in part, a so-called “persistent password” feature well understood by those skilled in the art. Examples of web-based systems having such a feature can be readily located.

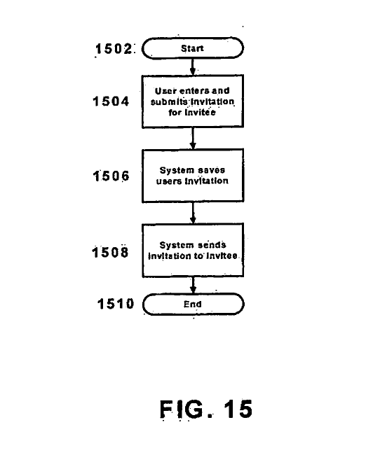

FIG. 15 depicts a flowchart of a process associated with inviting another registered user to set up a mutual affiliation. The steps illustrated include starting when a user interacts with the system to invite another user to set up a mutual affiliation, user entry and submission of the necessary information to identify the invitee, initiation of a system process that stores the request into the data store, and sending an invitation to the invitee.

Step 1502 is an entry point to the process.

In step 1504, a user, the inviter, requests an invitation to mutually affiliate. In this step the inviter can enter and/or submit information that identifies the invitee.

In step 1506, the inviter initiates a system process and that process stores a request to issue an invitation.

In step 1508, the system sends an invitation to the invitee.

Step 1510 is an exit point of the process.

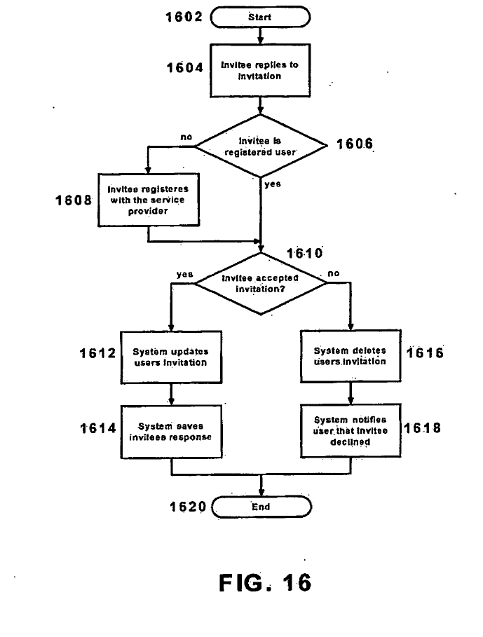

FIG. 16 depicts a flowchart of a process associated with a user, the invitee, accepting or declining an invitation from another user, the inviter, for a mutual affiliation.

In one embodiment, if an invitee has not yet registered with the service, the blocks depicting registration are traversed. An invitee interacts with the system. The system provides a method to the invitee to register with the service. The invitee enters and submits the required information. The system checks the data provided for missing or invalid information. In some embodiments, if the data provided by the invitee contains missing or invalid information, the system provides a method to the user to correct and resubmit the information. In one embodiment, the steps just described are repeated until the provided data passes a validity check. An invitee that successfully completes the registration process is then considered a registered user, and the remaining process flow applies.

A user interacts with the system to review and respond to an invitation to set up a mutual affiliation, the invitation having been initiated by another user, the inviter. For each invitation, the invitee can be given two choices. If the invitee accepts the invitation, the system creates and make persistent (“persists”) the invitee's response and updates any previously persisted invitation to reflect the establishment of a mutual affiliation.

Alternatively, the invitee can decline the invitation. In one embodiment, in the event of an invitee having declined the invitation, the system can send a notice of the declined invitation to the inviter, reflecting the invitee's choice. The system can then remove the previously persisted invitation. In some embodiments the previously persisted invitation must be persistent so that the sender of the invitation, and the invitee, can each view the invitation in the context of their respective schedules.

Step 1602 is an entry point to the process. In step 1604 an invitee replies to an extant invitation. Step 1606 splits control flow depending upon the registration status of the invitee. If the invitee is a registered user, control continues directly to step 1610. Otherwise, the invitee can register with the service as illustrated by step 1608, and control continues to step 1610.

Step 1610 splits control flow depending upon the invitee's acceptance or decline of the invitation. For an acceptance, control flow continues to step 1612. For a decline, control flow continues to step 1616.

In step 1612 the system updates an invitation record to reflect the invitee's acceptance. In step 1614 the system persists the invitee's response and updates any previously persisted invitations to reflect the establishment of a mutual affiliation. By way of non-limiting example, in the event that two users are at once inviters and invitees with respect to each other, an acceptance of one invitation will obviate the other invitation. That is, mutual affiliation requires only one invitation and acceptance. Control flow then passes to step 1620.

In step 1616 the system deletes the invitation. In step 1618, in some embodiments, the system can notify the inviter that the invitation was declined.

Step 1620 is an exit point to the process.

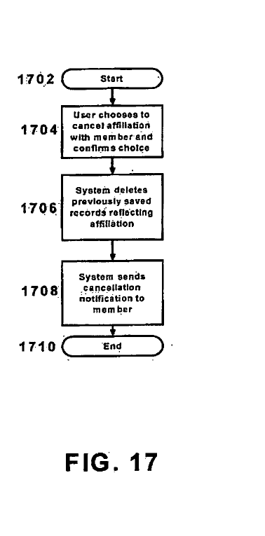

FIG. 17 depicts a flowchart of a process associated with deleting an existing affiliation.

The steps shown for this process can be initiated by a user, a member, that has an affiliation with another user, that is, another member. The process starts when a user interacts with the system to cancel a mutual affiliation with a member. The system provides a method of locating and choosing a particular existing mutual affiliation with a member. Upon the user confirming cancellation of a mutual affiliation, the system deletes all records associated with that mutual affiliation from the data store and, in some embodiments, can send a notice of cancellation to one or both members of the affiliation.

Step 1702 is an entry point to the process.

In step 1704 a first member chooses to cancel an affiliation with a second member.

In step 1706 the system deletes records of the affiliation.

In step 1708 the system can send a notice of cancellation to the first member and/or the second member.

Step 1710 is an exit point to the process.

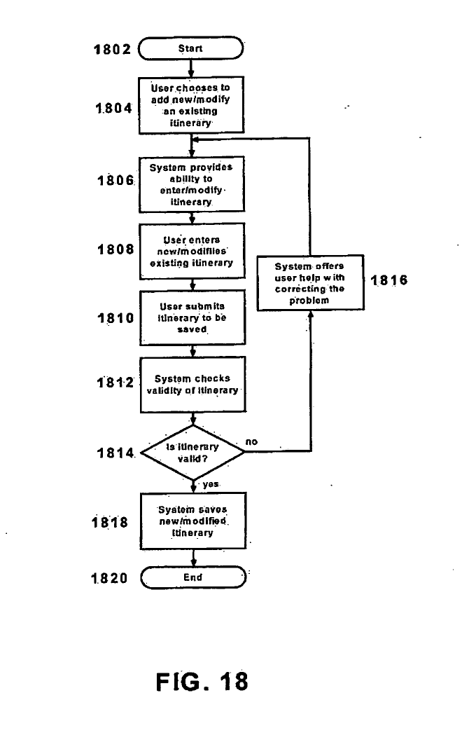

FIG. 18 depicts a flowchart of a process associated with adding a new or modifying an existing itinerary. If a user chooses to enter a new itinerary, the system provides a method of entering the itinerary information. The user can then enter and submit the itinerary information for validity checking. If the information passes a validity check, the itinerary can be saved to a data store. If, however, the itinerary contains invalid or missing information, the system, in some embodiments, can provide assistance for the user that can be helpful in correcting problems. The validation/correction steps can be repeated until the itinerary information passes a validity check.

Step 1802 is an entry point to the process.

In step 1804 a user chooses to add a new itinerary or to modify an existing itinerary.

In step 1806 the system provides a capability for the user to add a new itinerary or to modify an existing itinerary.

In step 1808 the user adds a new itinerary or modifies an existing itinerary.

In step 1810 the user submits the new or modified itinerary information to the system.

In step 1812 the system performs a validity check upon the new or modified itinerary information.

Step 1814 splits control flow depending upon results of the validity check. If the itinerary is not valid, control continues to step 1816. At step 1816 the system can offer assistance to the user that can be helpful in correcting problems. After step 1816 control continues to step 1806. Step 1806 provides an opportunity to modify and/or correct the submitted information, in hopes of achieving a successful validity check.

If the result of the validity check of step 1814 indicates valid information, then control continues to step 1818.

In step 1818 the system records, that is, saves, the new and/or modified itinerary.

Step 1820 is an exit point to the process.

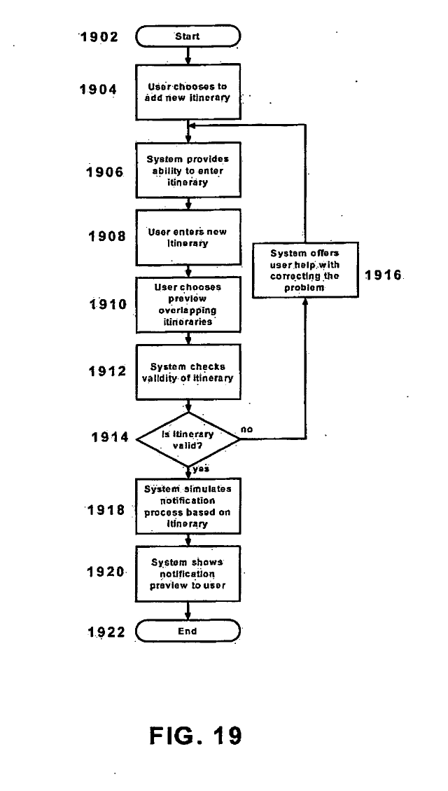

FIG. 19 similarly depicts a flowchart of a process associated with a user adding a new or modifying an existing itinerary, and previewing itineraries corresponding to schedule overlaps with members of that user. After a data entry and a validation process, a user can request the generation of a preview of notifications that the system could send as a result of comparing the just-entered or just-modified itinerary with itineraries already stored. Should the results of the preview be salutary, a process substantially similar to that illustrated in FIG. 15 may be followed, resulting in the saving of the previewed itinerary.

Step 1902 is an entry point to the process.

In step 1904 a user chooses to add a new itinerary.

In step 1906 the system provides a capability for the user to add a new itinerary.

In step 1908 the user adds a new itinerary.

In step 1910 the user chooses to preview itineraries corresponding to schedule overlaps amongst the user and members of that user.

In step 1912 the system performs a validity check upon the new itinerary information.

Step 1914 splits control flow depending upon results of the validity check. If the itinerary is not valid, control continues to step 1916. At step 1916 the system can offer assistance to the user that can be helpful in correcting problems. After step 1916 control continues to step 1906. Step 1906 provides an opportunity to modify and/or correct the submitted information, in hopes of achieving a successful validity check. If the result of the validity check of step 1914 indicates valid information, then control continues to step 1918.

In step 1918 the system can generate a preview of notifications. These notifications can be those that the system could send as a result of detecting one or more schedule overlaps when comparing the just-entered or just-modified itinerary with itineraries already stored. That is, these notifications represent a simulation of upcoming notification events that could occur in the event that the specified itinerary modifications take place.

In step 1920 the system provides the user access to the simulated notifications.

Step 1922 is an exit point to the process.

In either of the processes of FIG. 18 or FIG. 19, in some embodiments, creation of an itinerary can be made in concert with external entities, including, without limitation, airline travel reservation systems, restaurant reservation systems, rental car reservation systems and hotel reservation systems. In still further embodiments, advertising can be provided to the user. In yet further embodiments, the advertising can be tailored responsive to a user's itinerary and/or responsive to the user's and affected members' schedules.

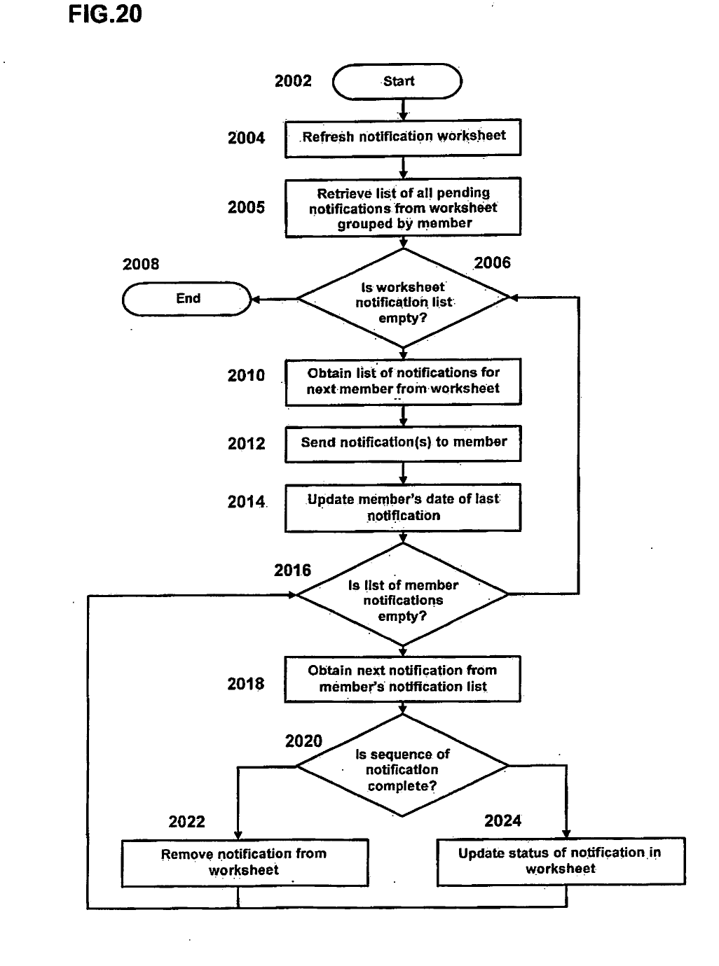

FIG. 20 depicts a flowchart of a process for automatically detecting status change in a database thus conditionally triggering the generation and/or issuance of one or more notification messages. In some embodiments, the process can begin by initializing a notification snapshot in a database worksheet table for each notification. The notifications can be sent to a user whereupon the user's last date of notification can then be updated in the database. Notifications can be updated as the notification process continues; notifications can be removed after the notification sequence is complete.

Step 2002 is an entry point to the process.

In step 2004 a notification worksheet is refreshed. In some embodiments the notification worksheet can be refreshed periodically. By way of non-limiting example the notification worksheet can be refreshed at five-minute intervals in some embodiments. In some embodiments the notification worksheet can comprise a list of entries in a database of notifications, wherein the notifications are associated with pending action, wherein the pending actions can comprise by way of non-limiting example, the issuance of a notification message. Step 2005 retrieves the list of all pending notifications from the worksheet. Step 2006 splits control flow depending upon whether any notifications remain to be processed by the process described herein. If there are notifications remaining to be processed, control continues to step 2010. If there are no notifications remaining to be processed, control proceeds to step 2008.

Step 2008 is an exit point to the process.

In step 2010, the system obtains a group of notifications for a next member from the list of all pending notifications.

In step 2012, the system sends one or more notifications to the member of step 2010.

In step 2014, a date of last notification is updated for the member of step 2010.

Step 2016 splits control flow depending upon whether any notifications remain in a list of notifications corresponding to a particular member. If there are no notifications remaining, control continues to step 2006.

If there are notifications corresponding to the particular member remaining, control continues to step 2018. In step 2018, the system obtains the next notification from the member's list of notifications. Control continues to step 2020.

Step 2020 splits control flow depending upon completion of the notification sequence. By way of non-limiting example, in some embodiments, if a notification message has been issued due to a previously-detected schedule overlap having been obviated by an itinerary change, a notification sequence has been completed for that circumstance. If the notification sequence is complete for a notification, then control continues to step 2022.

Step 2022 removes the notification from the worksheet. Control continues to step 2016.

If the notification sequence is incomplete, then the system updates notification status in a worksheet. Control continues to step 2016.

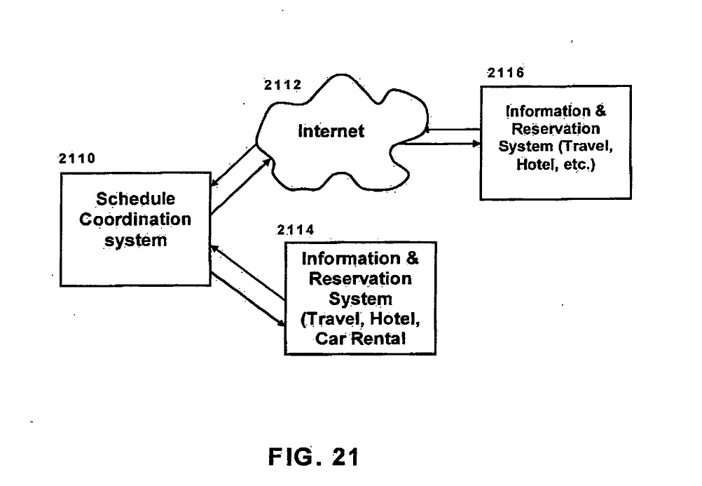

FIG. 21 depicts the interoperation of a schedule coordination system 2110 with a variety of information and reservation systems, local as well as remote, e.g., connected via the Internet 2112, in an embodiment. A schedule coordination system 2110 can communicate with at least one of a local or remote service provider. A local information and/or reservation system 2114 can interoperate with the schedule coordination system 2110 via a relatively small amount of intervening distance and/or intermediate machinery and/or protocols. A remote information and/or reservation system 2116 can interoperate with the schedule coordination system 2110 via a relatively large amount of intervening distance and/or intermediate machinery and/or protocols. Exemplary service providers can include, without limitation, airline travel reservation systems, restaurant reservation systems, rental car reservation systems and hotel reservation systems. In some embodiments, remote systems can be accessed via the interne.

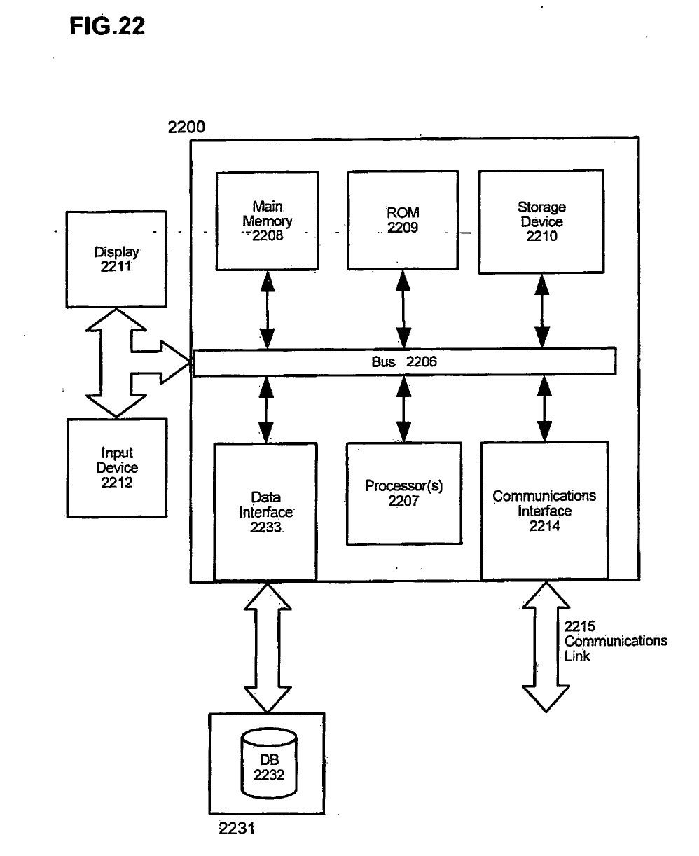

A computer system 2200 according to an embodiment will now be described with reference to FIG. 22, which is a block diagram of the functional components of a computer system 2200. As used herein, the term computer system 2200 is broadly used to describe any computing device that can store and independently run one or more programs.

Each computer system 2200 can include a communication interface 2214 coupled to the bus 2206. The communication interface 2214 provides two-way communication between computer systems 2200. The communication interface 2214 of a respective computer system 2200 transmits and receives electrical, electromagnetic or optical signals that include data streams representing various types of signal information, e.g., instructions, messages and data. A communication link 2215 links one computer system 2200 with another computer system 2200. For example, the communication link 2215 can be a LAN, in which case the communication interface 2214 can be a LAN card, or the communication link 2215 can be a PSTN, in which case the communication interface 2214 can be an integrated services digital network (ISDN) card or a modem, or the communication link 2215 can be the Internet, in which case the communication interface 2214 can be a dial-up, cable or wireless modem.

A computer system 2200 can transmit and receive messages, data, and instructions, including program, i.e., application, code, through its respective communication link 2215 and communication interface 2214. Received program code can be executed by the respective processor(s) 2207 as it is received, and/or stored in the storage device 2210, or other associated non-volatile media, for later execution.

In an embodiment, the computer system 2200 operates in conjunction with a data storage system 2231, e.g., a data storage system 2231 that contains a database 2232 that is readily accessible by the computer system 2200. The computer system 2200 communicates with the data storage system 2231 through a data interface 2233. A data interface 2233, which is coupled to the bus 2206, transmits and receives electrical, electromagnetic or optical signals that include data streams representing various types of signal information, e.g., instructions, messages and data. In embodiments, the functions of the data interface 2233 can be performed by the communication interface 2214.

Computer system 2200 includes a bus 2206 or other communication mechanism for communicating instructions, messages and data, collectively, information, and one or more processors 2207 coupled with the bus 2206 for processing information. Computer system 2200 also includes a main memory 2208, such as a random access memory (RAM) or other dynamic storage device, coupled to the bus 2206 for storing dynamic data and instructions to be executed by the processor(s) 2207. The main memory 2208 also can be used for storing temporary data, i.e., variables, or other intermediate information during execution of instructions by the processor(s) 2207.

The computer system 2200 can further include a read only memory (ROM) 2209 or other static storage device coupled to the bus 2206 for storing static data and instructions for the processor(s) 2207. A storage device 2210, such as a magnetic disk or optical disk, can also be provided and coupled to the bus 2206 for storing data and instructions for the processor(s) 2207.

A computer system 2200 can be coupled via the bus 2206 to a display device 2211, such as, but not limited to, a cathode ray tube (CRT), for displaying information to a user. An input device 2212, e.g., alphanumeric and other keys, is coupled to the bus 2206 for communicating information and command selections to the processor(s) 2207.

According to one embodiment, an individual computer system 2200 performs specific operations by its respective processor(s) 2207 executing one or more sequences of one or more instructions contained in the main memory 2208. Such instructions can be read into the main memory 2208 from another computer-usable medium, such as the ROM 2209 or the storage device 2210. Execution of the sequences of instructions contained in the main memory 2208 causes the processor(s) 2207 to perform the processes described herein. In alternative embodiments, hard-wired circuitry can be used in place of or in combination with software instructions. Thus, embodiments are not limited to any specific combination of hardware circuitry and/or software. The term “computer-usable medium,” as used herein, refers to any medium that provides information or is usable by the processor(s) 2207. Such a medium can take many forms, including, but not limited to, non-volatile, volatile and transmission media. Non-volatile media, i.e., media that can retain information in the absence of power, includes the ROM 2209, CD ROM, magnetic tape, and magnetic discs. Volatile media, i.e., media that can not retain information in the absence of power, includes the main memory 2208. Transmission media includes coaxial cables, copper wire and fiber optics, including the wires that comprise the bus 2206. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

Notably, the term “schedule overlap” as used herein, can denote a non-limiting example of a state that satisfies the requirements of a notification criterion.

The requirements of a notification criterion are described herein and with particularity in the section entitled: Notification Criterion Detection.

By way of non-limiting example, a literal schedule overlap can satisfy the requirements of a notification criterion. However, notification criterion is not so limited. In some embodiments, notification criterion can be satisfied without meeting the requirements of a literal schedule overlap.

This understanding of the term “schedule overlap” applies with particularity at least to:
schedule coordination system 301 and the description thereof, particularly with regards to 302 overlap;
the class diagram of FIG. 6 and the description thereof, particularly with regards to Overlap 613; and,
the flowchart of FIG. 19 and the description thereof, particularly with regards to steps 1910 and 1918.

An embodiment of a literal schedule overlap can comprise a state wherein schedules, respectively corresponding to two or more individuals, together satisfy constraints of simultaneity in location for at least a finite period of time. That is, an actual overlap in time and location can be required in order to satisfy the requirements of a literal schedule overlap.

The constraints of a literal schedule overlap can be described in terms of tolerances on time and location, with regards to specific entries two or more schedules. By way of example, an entry in a first schedule can comprise a specific time span and a specific location. The tolerances associated with the constraints of a literal overlap, in regard to time and location, are both essentially zero. That is, in order to mutually satisfy the constraints, an entry in another schedule will have to at least in part be essentially within a tolerance of zero time duration of the first entry in the first schedule; the entries must be scheduled at least in part to occur at the same time. Further, an entry in the second schedule will have to at least in part be essentially located within a tolerance of zero distance of the first entry in the first schedule; the entries must at least in part indicate essentially the same location in order to meet the location constraint.

Diagram 2301 depicts an exemplary itinerary.

Diagram 2301 depicts the itinerary elements according to map geography 2316, and timeline 2317, and with reference to the FIG. 5 class diagram of an itinerary embodiment. Notably, the itinerary embodiment comprises an itinerary leg, Leg 511.

An exemplary itinerary comprises specified travel legs 2302 and 2304. Travel leg 2302 comprises origin location 2308, destination location 2310, and specified transportation between the locations, scheduled to occur as indicated by travel leg time span 2332.

Travel leg 2304 comprises origin location 2312, destination location 2314, and specified transportation between the locations, scheduled to occur as indicated by travel leg time span 2334. As depicted in an embodiment, destination location 2310 and origin location 2312 can be essentially the same location.

A span comprising chronological and geographical coordinates can specify span 2306. Span 2306 is disposed immediately between the specified travel legs. Span 2306 is of finite, non-zero duration. The chronological coordinates 2336 of span 2306 are depicted along the time line 2317, corresponding to the time interval between arrival at location 2310 per travel leg 2302, and departure from essentially the same location 2312 per travel leg 2304. In some embodiments, a span such as Span 2306 occurs between and as a result of specified travel legs of an itinerary, but the span may not be specified directly in the itinerary. Thus, in some embodiments, an intermediate span such as Span 2306 may be described as ‘found’ and/or ‘discovered’ and/or ‘disposed’ between specified travel legs.

Diagram 2401 depicts exemplary geographic tolerances corresponding to conditions for detection of a notification criterion.

In some embodiments, the satisfaction of the requirements of a Notification Criterion can be described as Notification Criterion Satisfied (NCS).

In some embodiments, NCS can require at least satisfaction of a mutual geographic proximity constraint, which can be described by geographic tolerances corresponding respectively to two or more itineraries. A first tolerance 2412, corresponding to a first itinerary is depicted with respect to a location 2410 within a two-dimensional geography of the page. A second tolerance 2422, corresponding to a second itinerary is depicted with respect to a second location 2420. A correspondence of a specific tolerance to a specific itinerary corresponding to a specific user can be made as described in the section entitled: Notification Criterion Detection; the function of identifying a helpful degree of proximity amongst the itineraries of two users can be responsive to preferences of users. Such tolerances can correspond to individual preferences of individual users. In some embodiments such tolerances can be asymmetric. By way of non-limiting example, a geographic tolerance corresponding to a user can comprise a tolerance of 5 miles north but only 2 miles east of a specified location.

A first location 2410 can correspond to an entry in a first itinerary. A second location 2420 can correspond to an entry in a second itinerary. In some embodiments, NCS can require identifying a location that is within the tolerances corresponding to both itineraries. Such a location 2432 is depicted in diagram 2401. Such a location 2432 can be described as a span of geographic coordinates. Notably, the requirement can be satisfied without requiring that the specific location 2410 corresponding to an entry in a first itinerary be within the tolerance 2422 corresponding to a second itinerary. In a symmetric fashion, this requirement can be satisfied without requiring that the specific location 2420 corresponding to an entry in a second itinerary be within the tolerance 2412 corresponding to a first itinerary.

Such two-dimensional (2D) representations of geographic tolerances can be projected onto one-dimensional representations, such as depicted herein. The axes 2450, representing a spatial axis, and elements upon them each correspond to a one-dimensional representation of the more complex geometry depicted nearby. Bar 2421 corresponds to location 2420 and tolerance 2422. Bar 2411 corresponds to location 2410 and tolerance 2412. Bar 2402 corresponds to the area 2432 of NCS, of an embodiment. It can be appreciated that axes 2450 can be advantageously aligned within two dimensions to represent various geometries of tolerances that are aligned differently than the depicted example.

Diagram 2501 depicts exemplary combinations of geographic and chronological tolerances.

The geographic tolerances of diagram 2401 are combined with chronological tolerances, as depicted in diagram 2501. As such, the geographic entities of diagram 2401 map directly to their respectively corresponding representations in diagram 2501. Axes 2450 correspond to Axes 2550. Bars 2402 2411 2421 correspond to bars 2502 2511 2521.

Locations 2420 and 2410 correspond respectively to events 2520 2510. Events 2520 2510 each have in addition to a distinct specified corresponding location, a distinct specified corresponding timespan, depicted along time axes 2552.

A first chronological tolerance 2512 can correspond to entries of a first itinerary, these entries also corresponding to the geographical tolerance 2511 and 2411. This combination of tolerances of an embodiment is depicted as combined tolerance 2514. A second chronological tolerance 2522 can correspond to entries of a second itinerary, these entries also corresponding to geographical tolerance 2521 and 2421. This combination of tolerances of an embodiment is depicted as combined tolerance 2524.

In some embodiments NCS can require identifying a timespan, that is, a span of chronological coordinates, that is within the chronological tolerances corresponding to both itineraries. Such a timespan 2503 is depicted in diagram 2501. Notably, the requirement can be satisfied without requiring that the specific timespan corresponding to a first itinerary 2510 be within the tolerance 2522 corresponding to a second itinerary. In a symmetric fashion, this requirement can be satisfied without requiring that the specific timespan corresponding to a second itinerary 2520 be within the tolerance 2512 corresponding to the first itinerary. However, in the depicted example, the timespan associated with the first itinerary 2510 does at least partially lie within the chronological tolerance 2522 associated with the second itinerary.

In some embodiments chronological tolerances can be asymmetric. By way of non-limiting example, a chronological tolerance corresponding to a user can comprise a tolerance of 5 hours later but only 2 hours earlier than a specified time.

In some embodiments, NCS can require identifying a state that is within the combined tolerances corresponding to both itineraries. Such a state 2554 is depicted in diagram 2501. Such a state 2554 can be described as a span of geographic and chronological coordinates.

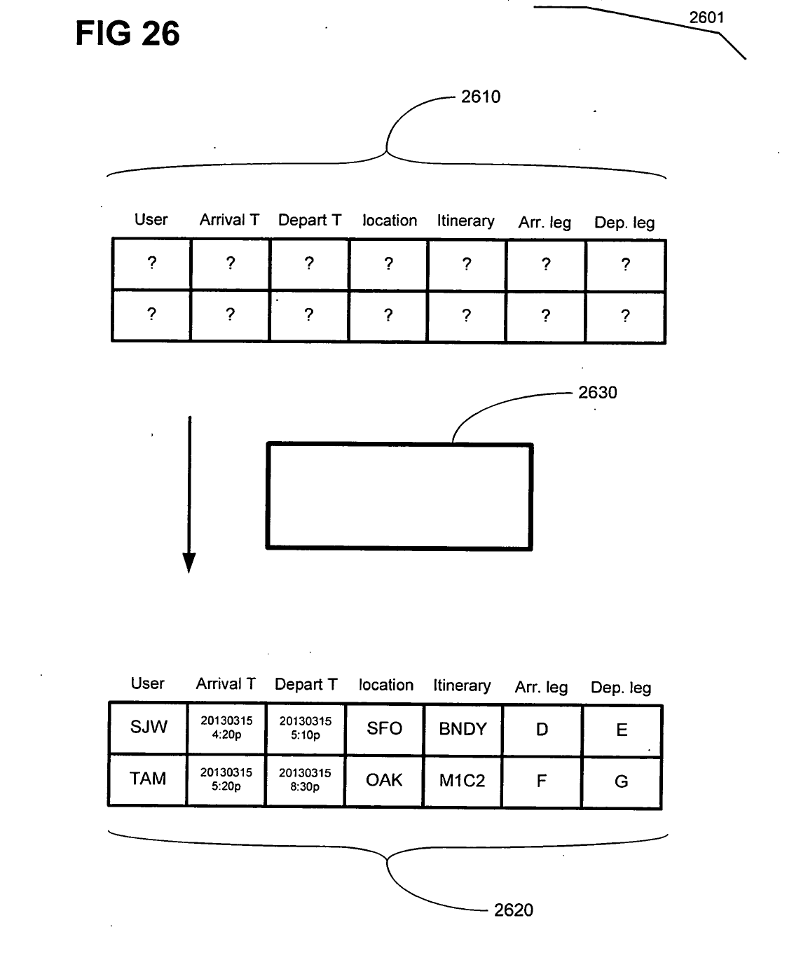

FIG. 26 depicts states of notification criterion detection.

A first state 2610 depicts elements corresponding to a Notification Criterion, prior to analysis of a plurality of itineraries. In some embodiments, the elements are not preconditioned. That is, the values of the elements have not been determined, prior to performing process 2630. Notably, the elements are specifically not preconditioned to specify Users whose itineraries may satisfy the Notification Criterion requirements. Nor are the elements preconditioned with specific locations, that is, geographic coordinates. Nor are the elements preconditioned with specific times, that is, chronological coordinates.

A process of analyzing a plurality of itineraries 2630 can subsequently be performed. In some embodiments the itineraries can be within a database. In some embodiments the database can comprise a plurality of itineraries, with the itineraries respectively corresponding to a plurality of users. The analysis process can be as described herein, particularly with reference to FIG. 8 and description thereof. In some embodiments this (Notification) criterion can be sought in a database search. Such a search and the mechanisms for performing such a search are well understood in the art. Notably, in some embodiments, the plurality of itineraries can comprise a large number of itineraries and the plurality of users can comprise a large number of users. It follows that in some embodiments the analysis process can be non-trivial with regards to specific analysis techniques and/or resource requirements.

In some embodiments, the analysis process 2630 can be initiated in response to automatically detecting a status change in the database. In some embodiments, the analysis process 2630 can be initiated in response to a timer. By way of non-limiting example, in some embodiments the analysis process 2630 can be initiated at five-minute intervals. In some embodiments that analysis process 2630 can be initiated in response to any known and/or convenient event and/or process. Notably, in some embodiments, User input and/or interaction is not required to initiate the analysis process 2630. The analysis process 2630 can detect satisfaction of a Notification Criterion, and provide an indication of Notification Criterion detected.

A second state 2620 depicts elements corresponding to a Notification Criterion, subsequent to detection of a Notification Criterion. Notably, in some embodiments, the Users, geographic coordinates, (identified) itineraries and legs, and chronological coordinates of the detected Notification Criterion, were not preconditioned. The example depicts a detected Notification Criterion that comprises geographic and chronological proximity. Notably, in the depicted embodiment, the Notification Criterion can be satisfied by conditions meeting mutual chronological and geographical tolerances that correspond to the specified itineraries.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

1. A system for coordinating schedules, comprising:
a processor configured to periodically search a database comprising three or more itineraries, and thereby detect a notification criterion corresponding to a first itinerary and a second itinerary among the three or more itineraries;
wherein the first itinerary corresponds to a first registered user among three or more registered users, the second itinerary corresponds to a second registered user among the three or more registered users, and, other itineraries among the three or more itineraries correspond to registered users among the three or more registered users;
wherein the processor is configured to notate the detected notification criterion and instantiate a notation in a computer-usable medium, wherein the notation associates the detected notification criterion with the first itinerary, the second itinerary, the first registered user, and the second registered user;
wherein the detected notification criterion comprises at least an upcoming point in time, and, a position;
wherein the upcoming point in time in combination with a point in the first itinerary meets a first chronological tolerance;
wherein the upcoming point in time in combination with a point in the second itinerary meets a second chronological tolerance;
wherein the position in combination with the point in the first itinerary meets a first geographic tolerance; and,
wherein the position in combination with the point in the second itinerary meets a second geographic tolerance.

2. The system of claim 1:
wherein first user preferences comprise the first chronological tolerance and the first geographic tolerance, and, the first user preferences are associated with a registration record corresponding to the first registered user; and,
wherein second user preferences comprise the second chronological tolerance and the second geographic tolerance, and, the second user preferences are associated with a registration record corresponding to the second registered user.

3. The system of claim 1:
wherein the first itinerary and the second itinerary each comprise a plurality of legs;
wherein each leg comprises one arrival and one departure;
wherein each arrival comprises a corresponding arrival date and time and a corresponding arrival location;
wherein each departure comprises a corresponding departure date and time and a corresponding departure location; and,
wherein each leg comprises a transportation event of non-zero time duration and non-zero geographic distance, taking place between the corresponding departure location and the corresponding arrival location.

4. A process for coordinating schedules, comprising the steps of:
periodically searching a database comprising three or more itineraries, thereby detecting a notification criterion corresponding to a first itinerary and a second itinerary among the three or more itineraries;
wherein the first itinerary corresponds to a first registered user among three or more registered users, the second itinerary corresponds to a second registered user among the three or more registered users, and, other itineraries among the three or more itineraries correspond to registered users among the three or more registered users;
notating the detected notification criterion, wherein a notation associates the detected notification criterion with the first itinerary, the second itinerary, the first registered user, and the second registered user;
instantiating the notation in a computer-usable medium;
wherein searching the database, notating the detected notification criterion, and, instantiating the notation, are each at least partially performed by automated execution of a computer program;
wherein the detected notification criterion comprises at least an upcoming point in time, and, a position;
wherein the upcoming point in time in combination with a point in the first itinerary meets a first chronological tolerance;
wherein the upcoming point in time in combination with a point in the second itinerary meets a second chronological tolerance;
wherein the position in combination with the point in the first itinerary meets a first geographic tolerance;
wherein the position in combination with the point in the second itinerary meets a second geographic tolerance;
wherein the first itinerary and the second itinerary each comprise a plurality of legs;
wherein each leg comprises one arrival and one departure;
wherein each arrival comprises a corresponding arrival date and time and a corresponding arrival location;
wherein each departure comprises a corresponding departure date and time and a corresponding departure location; and,
wherein each leg comprises a transportation event of non-zero time duration and non-zero geographic distance, taking place between the corresponding departure location and the corresponding arrival location.

5. The process of claim 4, further comprising the step of:
issuing a notification of the detected notification criterion to a specific user that is one of the first registered user and the second registered user.

6. The process of claim 5, further comprising the step of:
selectively including an advertisement in the notification, wherein selection of the advertisement is responsive to a user registration record corresponding to the specific user.

7. The process of claim 5, further comprising the step of:
selectively including an advertisement in the notification, wherein selection of the advertisement is responsive to at least one itinerary corresponding to the specific user.

8. The process of claim 4, further comprising the step of:
extracting schedule information from at least one message in order to at least in part provide one of the itineraries of the three or more itineraries.

9. The process of claim 4, further comprising the step of:
issuing an invitation to one of the three or more registered users, wherein the invitation enables the one user to selectively affiliate with another of the three or more registered users.

10. The process of claim 4, further comprising the steps of:
providing a first unregistered user; and,
issuing an invitation to the first unregistered user, wherein the invitation enables the first unregistered user to selectively affiliate with one of the three or more registered users upon the first unregistered user achieving a registered state.

11. The process of claim 4:
wherein first user preferences comprise the first chronological tolerance and the first geographic tolerance, and, the first user preferences are associated with a registration record corresponding to the first registered user; and,
wherein second user preferences comprise the second chronological tolerance and the second geographic tolerance, and, the second user preferences are associated with a registration record corresponding to the second registered user.

12. A system for coordinating schedules, comprising:
a processor configured to periodically search a database comprising three or more itineraries, and thereby detect a notification criterion corresponding to a first itinerary and a second itinerary among the three or more itineraries;
wherein the first itinerary corresponds to a first registered user among three or more registered users, the second itinerary corresponds to a second registered user among the three or more registered users, and, other itineraries among the three or more itineraries correspond to registered users among the three or more registered users;
wherein the processor is configured to notate the detected notification criterion and instantiate a notation in a computer-usable medium, wherein the notation associates the detected notification criterion with the first itinerary, the second itinerary, the first registered user, and the second registered user;
wherein the detected notification criterion comprises at least an upcoming point in time, and, a position;
wherein the upcoming point in time in combination with a point in the first itinerary meets a first chronological tolerance;
wherein the upcoming point in time in combination with a point in the second itinerary meets a second chronological tolerance;
wherein the position in combination with the point in the first itinerary meets a first geographic tolerance;
wherein the position in combination with the point in the second itinerary meets a second geographic tolerance;
wherein the first itinerary and the second itinerary each comprise a plurality of legs;
wherein each leg comprises one arrival and one departure;
wherein each arrival comprises a corresponding arrival date and time and a corresponding arrival location;
wherein each departure comprises a corresponding departure date and time and a corresponding departure location;
wherein each leg comprises a transportation event of non-zero time duration and non-zero geographic distance, taking place between the corresponding departure location and the corresponding arrival location;
wherein first user preferences comprise the first chronological tolerance and the first geographic tolerance, and, the first user preferences are associated with a registration record corresponding to the first registered user; and,
wherein second user preferences comprise the second chronological tolerance and the second geographic tolerance, and, the second user preferences are associated with a registration record corresponding to the second registered user.

13. The system of claim 12 wherein:
the processor is configured to issue a notification of the detected notification criterion to one of the first registered user and the second registered user,
extract schedule information from at least one message in order to at least in part provide one of the itineraries of the three or more itineraries, and,
issue an invitation to a specified user that is one of the three or more registered users, wherein the invitation enables the specified user to selectively affiliate with another of the three or more registered users.

14. A process for coordinating schedules, comprising the steps of:
periodically searching a database comprising three or more itineraries, thereby detecting a notification criterion corresponding to a first itinerary and a second itinerary among the three or more itineraries;
wherein the first itinerary corresponds to a first registered user among three or more registered users, the second itinerary corresponds to a second registered user among the three or more registered users, and, other itineraries among the three or more itineraries correspond to registered users among the three or more registered users;
notating the detected notification criterion, wherein a notation associates the detected notification criterion with the first itinerary, the second itinerary, the first registered user, and the second registered user;
instantiating the notation in a computer-usable medium;
wherein searching the database, notating the detected notification criterion, and, instantiating the notation, are each at least partially performed by automated execution of a computer program;
wherein the detected notification criterion comprises at least an upcoming point in time, and, a position;
wherein the upcoming point in time in combination with a point in the first itinerary meets a first chronological tolerance;
wherein the upcoming point in time in combination with a point in the second itinerary meets a second chronological tolerance;
wherein the position in combination with the point in the first itinerary meets a first geographic tolerance; and,
wherein the position in combination with the point in the second itinerary meets a second geographic tolerance.

15. The process of claim 14:
wherein the first itinerary and the second itinerary each comprise a plurality of legs;
wherein each leg comprises one arrival and one departure;
wherein each arrival comprises a corresponding arrival date and time and a corresponding arrival location;
wherein each departure comprises a corresponding departure date and time and a corresponding departure location; and,
wherein each leg comprises a transportation event of non-zero time duration and non-zero geographic distance, taking place between the corresponding departure location and the corresponding arrival location.
